(19) United States
(12) Patent Application Publication
(10) Pub. No.: US 2024/0239924 A1
(43) Pub. Date: Jul. 18, 2024

(54) SYNTHESIS OF SULFONYL HALIDE TERMINATED POLYETHYLENE

(71) Applicant: Dow Global Technologies LLC, Midland, MI (US)

(72) Inventors: Rachel E.M. Brooner, Midland, MI (US); Todd D. Senecal, Midland, MI (US); Zachary S. Kean, Midland, MI (US)

(73) Assignee: Dow Global Technologies LLC, Midland, MI (US)

(21) Appl. No.: 18/557,790

(22) PCT Filed: Apr. 29, 2022
(86) PCT No.: PCT/US2022/026914

§ 371 Date: Oct. 27, 2023

Related U.S. Application Data
(60) Provisional application No. 63/182,266, filed on Apr. 30, 2021.

(51) Int. Cl. C08F 8/34; C08F 8/06; C08F 8/12; C08F 210/14

(52) U.S. Cl. CPC C08F 8/34; C08F 8/06; C08F 8/12; C08F 210/14; C08F 2810/40

(57) ABSTRACT

Methods for preparing end-functionalized polyolefin, The methods include polymerizing one or more olefin monomers in the presence of an aluminum chain transfer agent to produce a polymeryl aluminum species; treating the polymeryl aluminum species with sulfur oxide compound at a reactor temperature to form a polymeryl sulfinate; and oxidizing the polymeryl sulfinate; wherein the end-functionalized polyolefin comprises a polymer backbone having at least 30 carbon atoms; and the end-functionalized polyolefin comprises a sulfur containing group,

### CROSS REFERENCE TO RELATED APPLICATIONS

This application claims the benefit of U.S. Provisional Application Ser. No. 63/182,266, filed Apr. 30, 2021, the entire disclosure of which is hereby incorporated herein by reference.

### TECHNICAL FIELD

Embodiments of the present disclosure generally relate to processes and methods to synthesize sulfonyl halide terminated ethylene-based polymer and sulfonate salt terminated ethylene-based polymer.

### BACKGROUND

Polyolefins, such as polyethylene (PE) and polypropylene (PP), have excellent physical properties and workability, On the other hand, high chemical stability of polyolefins is an obstacle for giving, thereto, high functionalities, typical examples of which include printability, paintability, heat resistance and impact resistance, and a function for improving compatibility thereof with other polar polymers. In recent years, advances in polymer design have been seen with the use of compositions capable of chain shuttling and/or chain transfer. Typical chain transfer agents are simple metal alkyls, such as trialkylaluminum. Upon polymerization in the presence of a chain transfer agent, polymeryl-metal intermediates can be produced, including but not limited to compounds having the formula AlP₃, with P being an oligo- or polymeric substituent. These polymeryl-aluminum intermediates can enable the synthesis of novel end-functional polyolefins with controlled molecular weight distributions, including polyolefins functionalized with sulfur containing groups.

### SUMMARY

A variety of methods are known for the preparation of alkyl sulfonates. However, most methods not proved entirely satisfactory to prepare sulfonyl chain-end functionalized polyolefins for one reason or another. Researchers have found it challenging to produce alkyl sulfonates with alkyl chains greater than 20 carbon atoms at a high yield.

Ongoing needs exist to develop methods of efficiently producing end-functionalized polyolefins. To efficiently produce end-functionalized polyolefins from polymeryl aluminum intermediates, methods are needed that operate at high temperatures, specifically temperatures from 100° C. to 200° C., and with yields of greater than 70%. To address the low reaction temperature and the low yields of previous methods, the methods of this disclosure focus on producing polymeryl aluminum and reacting the polymeryl aluminum to form an end functionalized polymer. The polymerization reaction occurs at higher temperatures (at or above 100° C.). Then, the polymeryl aluminum is reacted high temperatures and low functional group concentration to form the end-functionalized polyolefin.

Embodiments include methods for preparing end-functionalized polyolefin. The end-functionalized polyolefin includes a polymer backbone having at least 30 carbon atoms and a sulfur containing group. The method includes polymerizing one or more olefin monomers in the presence of a chain transfer agent to produce a polymeryl aluminum species. The polymeryl aluminum species is treated with a sulfur oxide compound at a reactor temperature to form a polymeryl sulfinate; and the polymeryl sulfinate is oxidized.

In some embodiments, the sulfur containing group includes a sulfonyl halide.

Embodiments of this disclosure include hydrolyzing the sulfonyl halide to produce a sulfonate salt.

Embodiments of this disclosure include a sulfonate end-functionalized polyolefin according to formula (I):

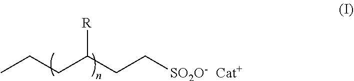

In formula (I), subscript n is an integer from 15 to 5,000, each R is independently hydrogen atom or (C₁-C₁₀)alkyl and Cat⁺ is a countercation

### DETAILED DESCRIPTION

Unless otherwise defined, all technical and scientific terms used herein have the same meaning as commonly understood by one of ordinary skill in the art to which this disclosure belongs. In case of conflict, the specification, including definitions, will control.

Although methods and materials similar or equivalent to those described herein can be used in the practice or testing of various embodiments, suitable methods and materials are described herein.

Unless stated otherwise, all percentages, parts, ratios, etc., are by weight. When an amount, concentration, or other value or parameter is given as either a range, preferred range, or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein. the terms “comprises,” “comprising.” “includes.” “including.” “containing.” “characterized by.” “has.” “having.” or any other variation thereof, are intended to cover a non-exclusive inclusion. For example, a process, method, article, or apparatus that comprises a list of elements is not necessarily limited to those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the disclosure. Where applicants have defined an embodiment or a portion thereof with an open-ended term such as “comprising.” unless otherwise stated, the description should be interpreted to also describe such an embodiment using the term “consisting essentially of.”

Use of “a” or “an” are employed to describe elements and components of various embodiments. This is merely for convenience and to give a general sense of the various embodiments. This description should be read to include one or at least one and the singular also includes the plural unless it is obvious that it is meant otherwise.

The term “polymer” refers to a compound prepared by polymerizing monomers. whether of the same or a different type. The generic term polymer thus embraces the terms “homopolymer” and “copolymer.” The term “homopolymer” refers to polymers prepared from only one type of monomer; the term “copolymer” refers to polymers prepared from two or more different monomers, and for the purpose of this disclosure may include “terpolymers” and “interpolymer.”

The term “chain transfer agent” refers to a compound or mixture of compounds that is capable of causing reversible or irreversible polymeryl exchange with active catalyst sites. Irreversible chain transfer refers to a transfer of a growing polymer chain from the active catalyst to the chain transfer agent that results in termination of polymer chain growth. Reversible chain transfer refers to transfers of growing polymer chain back and forth between the active catalyst and the chain transfer agent. The term “polymeryl” refers to a polymer missing one hydrogen atom on the carbon at the point of attachment, for example to the aluminum from the chain transfer agent.

In embodiments, the methods for preparing end-functionalized polyolefin include polymerizing one or more olefin monomers in the presence of an aluminum chain transfer agent to produce a polymeryl aluminum species. The polymeryl aluminum species is treated with a sulfur oxide compound at a reactor temperature to form a polymeryl sulfinate. The polymeryl sulfinate is oxidized to form the end-functionalized polyolefin. The end-functionalized polyolefin of this disclosure includes a polymer backbone having at least 30 carbon atoms and a sulfur containing group.

In one or more embodiments, olefin monomers polymerized in the presence of an aluminum chain transfer agent include (C₂-C₁₂)α-olefin monomers. In some embodiments, the olefin monomers include ethylene, propylene, 1-butene, 1-pentene, 1-hexene, 1-heptene, 1-octene, 1-nonene, 1-decene, 1-undecene, 1-decadene. In various embodiments, the olefin monomers are ethylene and 1-octene; ethylene and 1-hexene; ethylene and 1-butene; or ethylene and propylene.

In various embodiments, olefin monomers polymerized in the presence of an aluminum chain transfer agent, in which the aluminum chain transfer agent is AlR₃, where each R is independently (C₁-C₁₂)alkyl. In some embodiments. R is methyl, ethyl, n-propyl, 2-propyl, n-butyl, tert-butyl, iso-butyl, pentyl, hexyl, heptyl, n-octyl, tert-octyl, nonyl, decyl, undecyl, or dodecyl. Non-limiting examples of the aluminum chain transfer agent include triethyl aluminum, tri(i-propyl) aluminum, tri(i-butyl) aluminum, tri(n-hexyl) aluminum, and tri(n-octyl) aluminum.

The methods of this disclosure include polymerizing one or more olefin monomers in the presence of an aluminum chain transfer agent to produce a polymeryl aluminum species.

The process for preparing a polyolefin component that includes polymeryl aluminum species according to formula AlR₃₋ₙPₙ. In the formula AlR₃₋ₙPₙ. Al is aluminum, and each R is a (C₁-C₃₀)alkyl. Each P is independently an aliphatic hydrocarbyl having at least 30 carbon atoms. The subscript n is 1, 2, or 3.

In one or more embodiments, each P is independently an aliphatic hydrocarbyl having from at least 30 carbon atoms. In various embodiments, each P is independently an aliphatic hydrocarbyl having from 50 carbon atoms to 10,000 carbon atoms. In some embodiments, each P is independently an aliphatic hydrocarbyl having from 60 carbon atoms to 10,000 carbon atoms, from 70 carbon atoms to 5,000 carbon atoms, from 100 carbon atoms to 1,500 carbon atoms, or from 70 carbon atoms to 500 carbon atoms.

In some embodiments, each of P may have a number average molecular weight greater than 400 g/mol and less than 60,000 g/mol. In various embodiments, each of P may have a number average molecular weight greater than 1,200 g/mol and less than 30,000 g/mol. In various embodiments, each of P may have a number average molecular weight greater than 1,500 g/mol and less than 15,000 g/mol. In some embodiments, each of P may have a number average molecular weight greater than 1,200 g/mol and less than 12,000 g/mol

One or more embodiments of this disclosure include processes for preparing polymeryl aluminum species, the process includes polymerizing ethylene and optionally one or more (C₃-C₁₂)α-olefin in the presence of an aluminum chain transfer agent to produce a polymeryl aluminum species. In one or more embodiments, the polymerization process further includes a catalyst system. The catalysts system may include a procatalyst and an activator. The polymerization processes may include, but are not limited to, solution polymerization process, gas phase polymerization process, slurry phase polymerization process, and combinations thereof using one or more reactors such as loop reactors, isothermal reactors, fluidized bed gas phase reactors, continuous stirred tank reactors, batch reactors in parallel, series, and/or any combinations thereof.

The polymerization process of this disclosure may produce ethylene based polymers, for example homopolymers and/or interpolymers (including copolymers) of ethylene and optionally one or more comonomers such as α-olefins may, for example, be produced via solution-phase polymerization process using one or more loop reactors, isothermal reactors, and combinations thereof.

In some embodiments, the solution phase polymerization process occurs in one or more well-stirred reactors such as one or more loop reactors or one or more spherical isothermal reactors at a temperature in the range of from 80° C. to 180° C.; for example, from 100° C. to 150° C, and at pressures in the range of from 100 to 1500 psi. The residence time in solution phase polymerization process is typically in the range of from 2 to 30 minutes; for example, from 10 to 20 minutes. Ethylene, one or more solvents, one or more catalyst systems, such as catalyst system that includes a procatalyst according to the metal-ligand complex of formula (I), optionally one or more cocatalysts, and optionally one or more comonomers are fed continuously to the one or more reactors. Exemplary solvents include, but are not limited to, isoparaffins. For example, such solvents are commercially available under the name ISOPAR E from ExxonMobil Chemical Co., Houston, Texas. The resultant mixture of the ethylene based polymer, polymeryl aluminum, and solvent is then removed from the reactor.

In embodiments, the polymeryl aluminum species is treated with a sulfur oxide in a reactor at a reactor temperature. In some embodiments, the reactor temperature is heated to at least 80° C. In some embodiments the reactor temperature is in a range from 100° C. to 180° C. In various embodiments, the reactor temperature is from 120° C. to 160° C.

Embodiments of this disclosure include treating the polymeryl aluminum species with a sulfur oxide compound at a reactor temperature to form a polymerylsulfinate. In some embodiments, the sulfur oxide compound is sulfur dioxide.

In embodiments, the polymerylsulfinate is oxidized. In some embodiments, the polymerylsulfinate is oxidized with an oxidizing reagent. In one or more embodiments, the oxidizing agent that oxidizes that polymerylsulfinate includes, but is not limited to, chlorine (Cl₂), bromine (Br₂), fluorine (F₂), N-chlorosuccinimide, 1,3-dichloro-5,5-dimethylhydantoin, trichloroisocyanuric acid, N-bromosuccinimide, 1,3-dibromo-5,5-dimethylhydantoin, dibromoisocyanuric acid, 1-chloromethyl-4-fluoro-1,4-diazoniabicyclo[2.2.2]octane bis(tetrafluoroborate) (also known as Selectfluor™), 1-fluoropyridinium tetrafluoroborate, or N-fluorobenzenesulfonimide

The end-functionalized polyolefin of this disclosure includes a polymer backbone having at least 30 carbon atoms and a sulfur containing group. In some embodiments, the end-functionalized polyolefin includes a polymer backbone of greater than 50 carbon atoms, or greater than 80 carbon atoms. In various embodiments, the polymer backbone of the end-functionalized polyolefin includes from 50 carbon atoms to 10,000 carbon atoms. In one or more embodiments, the polymer backbone of the end-functionalized polyolefin includes from 60 carbon atoms to 10,000 carbon atoms, from 70 carbon atoms to 5,000 carbon atoms, from 100 carbon atoms to 1,500 carbon atoms, or from 70 carbon atoms to 500 carbon atoms.

In various embodiments, the method of this disclosure further includes hydrolyzing the sulfonyl halide to form a sulfonate salt.

In some embodiments, the end-functionalized polyolefin includes a sulfonate end-functionalized polyolefin according to formula (I):

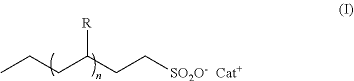

In formula (I), subscript n is from 15 to 5,000. Each R is independently hydrogen atom (—H) or (C₁-C₁₀)alkyl. The Cat⁺ is a countercation. In one or more embodiments, subscript n, in formula (II), is an from 20 to 5,000, 25 to 4,000, 30 to 2,500, 50 to 900, or from 35 to 250.

In some embodiments, in formula (I), when subscript n is an integer from 15 to 5,000, there are 15 to 5,000 group R. Each R is independently hydrogen atom (—H) or (C₁-C₁₀)alkyl. It is to be understood that if ethylene and one (C₃-C₁₂)α-olefin is polymerized, then each R is —H or (C₁-C₁₀)alkyl, resulting from the polymerization of ethylene and one (C₃-C₁₂)α-olefin, such as propene, butene, pentene, hexene, heptene, octene, nonene, decene, undecene, or dudecene.

In some embodiments, Cat⁺ is a proton (H⁺) or a metal cation having a formal charge of +1, +2, or +3. In various embodiments, the metal cation is an alkali metal or an alkaline earth metal. The alkali metal may include, but is not limited to, lithium, sodium, potassium, rubidium, or cesium. The alkaline earth metal may include, but is not limited to, magnesium, calcium, strontium, or barium. In one or more embodiments, Cat⁺ is selected from the group consisting of sodium, lithium, potassium, calcium, or magnesium. In various embodiments, the Cat⁺ is an aluminum cation having a formal charge of +3.

It is to be understood that if the countercation has a formal charge of +2, then a second anion species, such as a chloride anion or a second sulfonate end-functionalized polymer olefin is coordinated to countercation. Similarly, if the countercation has a formal charge of +3, then a second and a third anion species is coordinated to the countercation.

In one or more embodiments, the end-functionalized polyolefin includes a sulfonyl halide end-functionalized polyolefin according to formula (II):

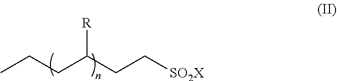

In formula (II), subscript n is from 15 to 5000. Each R is independently hydrogen atom (—H) or (C₁-C₁₀)alkyl, and X is a halogen atom. In one or more embodiments, subscript n, in formula (II), is an from 20 to 5,000, 25 to 4,000, 30 to 2,500, 50 to 900, or from 35 to 250.

In one or more embodiments, the sulfur-containing group is a sulfonyl halide. In various embodiments, the sulfonyl halide is selected from a sulfonyl chloride, sulfonyl bromide, or sulfonyl fluoride.

### Catalyst System

In further embodiments of this disclosure, olefin monomers are polymerized in the presence of an aluminum chain transfer agent and a catalyst system. The catalyst system includes one or more procatalyst.

In further embodiments, the catalyst system includes the procatalyst and a co-catalyst. whereby an active catalyst is formed by the combination of the procatalyst and the co-catalyst. In these embodiments, the catalyst system may include a ratio of the procatalyst to the co-catalyst of 1:2, or 1:1.5, or 1:1.2.

The catalyst system may include a procatalyst. The procatalyst may be rendered catalytically active by contacting the complex to, or combining the complex with, a metallic activator having anion of the catalyst and a countercation. The procatalyst may be chosen from a Group IV metal-ligand complex (Group IVB according to CAS or Group 4 according to IUPAC naming conventions), such as a titanium (Ti) metal-ligand complex, a zirconium (Zr) metal-ligand complex, or a hafnium (Hf) metal-ligand complex. Non-limiting examples of the procatalyst include catalysts, procatalysts, or catalytically active compounds for polymerizing ethylene-based polymers are disclosed in one or more of U.S. Pat. No. 8,372,927; WO 2010022228; WO 2011102989; U.S. Pat. Nos. 6,953,764; 6,900,321; WO 2017173080; U.S. Pat. No. 7,650,930; 6,777,509 WO 99/41294; U.S. Pat. No. 6,869,904; or WO 2007136496, all of which documents are incorporated herein by reference in their entirety.

Suitable procatalysts include but are not limited to those disclosed in WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,858,706 B2, 7,355,089 B2, 8,058,373 B2, and 8,785,554 B2. With reference to the paragraphs below, the term “procatalyst” is interchangeable with the terms “catalyst,” “precatalyst,” “catalyst precursor,” “transition metal catalyst,” “transition metal catalyst precursor,” “polymerization catalyst,” “polymerization catalyst precursor,” “transition metal complex,” “transition metal compound,” “metal complex,” “metal compound,” “complex,” and “metal-ligand complex,” and like terms.

In one or more embodiments, the Group IV metal-ligand procatalyst complex includes a bis(phenylphenoxy) Group IV metal-ligand complex or a constrained geometry Group IV metal-ligand complex.

According to some embodiments, the Group IV metal-ligand procatalyst complex may include a bis(phenylphenoxy) compound according to formula (X):

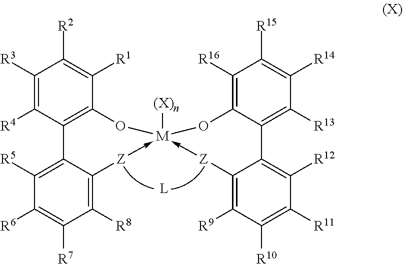

In formula (X), M is a metal chosen from titanium, zirconium, or hafnium, the metal being in a formal oxidation state of +2, +3, or +4. Subscript n of (X)ₙ is 0, 1, or 2. When subscript n is 1, X is a monodentate ligand or a bidentate ligand, and when subscript n is 2, each X is a monodentate ligand. L is a diradical selected from the group consisting of (C₁-C₄₀)hydrocarbylene, (C₁-C₄₀)heterohydrocarbylene, —Si(R^{C})₂—, —Si(R^{C})₂OSi(R^{C})₂—, —Si(R^{C})₂C(R^{C})₂—, —Si(R^{C})₂Si(R^{C})₂—, —Si(R^{C})₂C(R^{C})₂Si(R^{C})₂—, —C(R^{C})₂Si(R^{C})₂C(R^{C})₂—, —N(R^{N})C(R^{C})₂—, —N(R^{N})N(R^{N})—, —C(R^{C})₂N(R^{N})C(R^{C})₂—, —Ge(RC)₂—, —P(R^{P})—, —N(R^{N})—, —O—, —S—, —S(O)—, —S(O)₂—, —N═C(R^{C})—, —C(O)O—, —OC(O)—, —C(O)N(R)—, and —N(R^{C})C(O) —. Each Z is independently chosen from —O—, —S—, —N(R^{N})—, or —P(R^{P})—; R²-R⁴, R⁵-R⁻⁸, R⁹-R¹² and R¹³-R¹⁵ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —ORC, —SRC, —NO₂, —CN, —CF₃, R^{C}S(O)—, R^{C}S(O)₂—, —N═C(R^{C})₂, R^{C}C(O)O—, R^{C}OC(O)—, R^{C}C(O)N(R)—, (R^{C})₂NC(O)—, and halogen. R¹ and R¹⁶ are selected from radicals having formula (XI), radicals having formula (XII), and radicals having formula (XIII):

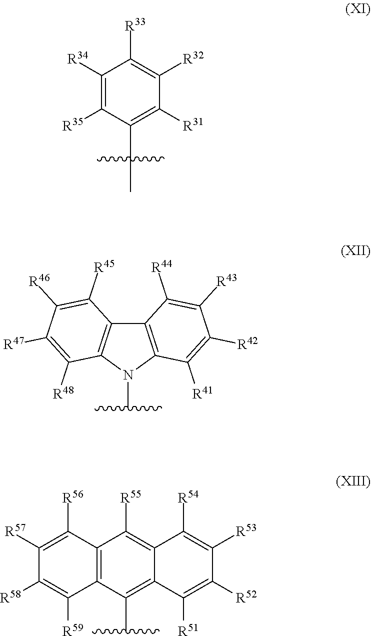

In formulas (XI), (XII), and (XIII), each of R³¹-R³⁵, R⁴¹-R⁴⁸, and R⁵¹-R⁵⁹ is independently chosen from —H, (C₁-C₄₀)hydrocarbyl, (C₁-C₄₀)heterohydrocarbyl, —Si(RC)₃, —Ge(RC)₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen.

In one or more embodiments, each X can be a monodentate ligand that, independently from any other ligands X, is a halogen, unsubstituted (C₁-C₂₀)hydrocarbyl, unsubstituted (C₁-C₂₀)hydrocarbylC(O)O—, or R^{K}R^{L}N—. wherein each of R^{K} and R^{L} independently is an unsubstituted(C₁-C₂₀)hydrocarbyl.

Illustrative bis(phenylphenoxy) metal-ligand complexes according to formula (X) include, for example:

(2′,2″-(propane-1,3-diylbis(oxy))bis(5′-chloro-3-(3,6-di-tert-octyl-9H-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(3-(3,6-di-tert-butyl-9H-carbazol-9-yl)-3′-chloro-5-(2,4,4-trimethylpentan-2-yl)biphenyl-2-ol)dimethyl-hafnium;

(2′,2″-(propane-1,3-diylbis(oxy))bis(3′-chloro-3-(3,6-di-tert-butyl-9H-carbazol-9-yl)-5′-fluoro-5-(2,4,4-trimethylpentan-2-yl)biphenyl-2-ol)dimethyl-hafnium;

(2′,2″-(propane-1,3-diylbis(oxy))bis(3-(3,6-di-tert-butyl-9H-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(S′-cyano-3-(3,6-di-tert-butyl-9H-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(5′-dimethylamino-3-(3,6-di-tert-butyl-9H-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(3′,5′-dimethyl-3-(3,6-di-tert-butyl-9H-carbazol-9-yl)-5-(2,4,4-trimethylpentan-2-yl)biphenyl-2-ol)dimethyl-hafnium;

(2′,2″-(propane-1,3-diylbis(oxy))bis(5′-chloro-3-(3,6-di-tert-butyl-9H-carbazol-9-yl)-3′-ethyl-5-(2,4,4-trimethylpentan-2-yl)biphenyl-2-ol)dimethyl-hafnium;

(2′,2″-(propane-1,3-diylbis(oxy))bis(3-(3,6-di-tert-butyl-9H-carbazol-9-yl)-3′-methyl-5′-tert-butyl-5-(2,4,4-trimethylpentan-2-yl)biphenyl-2-ol)dimethyl-hafnium;

(2′,2″-(propane-1,3-diylbis(oxy))bis(3-(3,6-di-tert-butyl-9H-carbazol-9-yl)-5′-fluoro-3′-methyl-5-(2,4,4-trimethylpentan-2-yl)biphenyl-2-ol)dimethyl-hafnium;

(2′,2″-(propane-1,3-diylbis(oxy))bis(3-(9H-carbazol-9-yl)-5′-chloro-3′-methyl-5-(2,4,4-trimethylpentan-2-yl)biphenyl-2-ol)dimethyl-hafnium:

(2,2″-(propane-1,3-diylbis(oxy)bis(3-(3,6-di-ter-butyl-9H-carbazol-9-y)-3′-methyl-S′-trifluoromethyl-5-(2,4,4-trimethylpentan-2-yl)biphenyl-2-ol)dimethyl-hafnium;

(2′,2″-(2,2-dimethyl-2-silapropane-1,3-diylbis(oxy))bis(3′,5′-dichloro-3-(3,6-di-tert-butyl-9H-carbazol-9-yl)-5-(2,4,4-trimethylpentan-2-yl)biphenyl-2-ol)dimethyl-hafnium;

(2′2″-(2,2-dimethyl-2-silapropane-1-diylbis(oxy)bis(S′-chloro-3-(3,6-di-tert-butyl-9-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(3′-bromo-5′-chloro-3-(3,6-di-tert-butyl-9H-carbazol-9-yl)-5-(2,4,4-trimethylpentan-2-yl)biphenyl-2-ol)dimethyl-hafnium;

(2′,2″-(propane-1,3-diylbis(oxy))-(5′-chloro-3-(3,6-di-tert-butyl-9H-carbazol-9-yl)-3′-fluoro-5-(2,4,4-trimethylpentan-2-yl)biphenyl-2-ol)-(3″, 5″-dichloro-3-(3,6-di-tert-butyl-9H-carbazol-9-yl)-5-(2,4,4-trimethylpentan-2-yl)biphenyl-2-ol)dimethyl-hafnium;

(2′,2″-(propane-1,3-diylbis(oxy))bis(3-(3,6-di-tert-butyl-9H-carbazol-9-yl)-S′-fluoro-3′-trifluoromethyl-5-(2,4,4-trimethylpentan-2-yl)biphenyl-2-ol)dimethyl-hafnium;

(2′,2″-(butane-1,4-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-hafnium;

(2′,2″-(ethane-1,2-diylbis(oxy))bis(5′-chloro-3-(3,6-di-tert-butyl-9H-carbazol-9-yl)-3′-methyl-5-(2,4,4-trimethylpentan-2-yl)biphenyl-2-ol)dimethyl-hafnium;

(2′,2″-(propane-1,3-diylbis(oxy))bis(S′-chloro-3-(3,6-di-tert-butyl-9H-carbazol-9-yl)-3′-methyl-5-(2,4,4-trimethylpentan-2-yl)biphenyl-2-ol)dimethyl-zirconium:

(2′,2″-(propane-1,3-diylbis(oxy)bis(3-(3,6-di-tert-butyl-9H-carbazol-9-yl)-31,5′-dichloro-5-(2,4,4-trimethylpentan-2-yl)biphenyl-2-ol)dimethyl-titanium; and

(2′,2″-(propane-1,3-diylbis(oxy))bis(S′-chloro-3-(3,6-di-tert-butyl-9H-carbazol-9-yl)-3′-methyl-5-(2,4,4-trimethylpentan-2-yl)biphenyl-2-ol)dimethyl-titanium.

Other bis(phenylphenoxy) metal-ligand complexes that may be used in combination with the metallic activators in the catalyst systems of this disclosure will be apparent to those skilled in the art.

According to some embodiments, the Group IV metal-ligand complex may include a cyclopentadienyl procatalyst according to formula (XIV):

LpᵢMXₘX′ₙX″ₚ, or a dimer thereof (XIV).

In formula (XIV), Lp is an anionic, delocalized, π-bonded group that is bound to M, containing up to 50 non-hydrogen atoms. In some embodiments of formula (XIV), two Lp groups may be joined together forming a bridged structure, and further optionally one Lp may be bound to X.

In formula (XIV). M is a metal of Group 4 of the Periodic Table of the Elements in the +2, +3 or +4 formal oxidation state. X is an optional, divalent substituent of up to 50 non-hydrogen atoms that together with Lp forms a metallocycle with M. X′ is an optional neutral ligand having up to 20 non hydrogen atoms; each X″ is independently a monovalent, anionic moiety having up to 40 non-hydrogen atoms. Optionally, two X″ groups may be covalently bound together forming a divalent dianionic moiety having both valences bound to M, or, optionally two X″ groups may be covalently bound together to form a neutral, conjugated or nonconjugated diene that is π-bonded to M, in which M is in the +2 oxidation state. In other embodiments, one or more X″ and one or more X′ groups may be bonded together thereby forming a moiety that is both covalently bound to M and coordinated thereto by means of Lewis base functionality. Subscript i of Lpᵢ is 0, 1, or 2; subscript n of X′ₙ is 0, 1, 2, or 3; subscript m of Xₘ is 0 or 1; and subscript p of X″ₚ is 0, 1, 2, or 3. The sum of i+m+p is equal to the formula oxidation state of M.

Illustrative Group IV metal-ligand complexes may include cyclopentadienyl procatalyst that may be employed in the practice of the present invention include: cyclopentadienyltitaniumtrimethyl; cyclopentadienyltitaniumtriethyl; cyclopentadienyltitaniumtriisopropyl; cyclopentadienyltitaniumtriphenyl;cyclopentadienyltitaniumitribenzyl; cyclopentadienyltitanium-2,4-dimethylpentadienyl; cyclopentadienyltitanium-2,4-dimethylpentadienyl·tricthylphosphine; cyclopentadienyltitanium-2,4-dimethylpentadienyl·trimethylphosphine; cyclopentadienyltitaniumdimethylmethoxide: cyclopentadienyltitaniumdimethylchloride; pentamethylcyclopentadienyltitaniumtrimethyl; indenyltitaniumtrimethyl; indenyltitaniumtriethyl; indenyltitaniumtripropyl; indenyltitaniumtriphenyl; tetrahydroindenyltitaniumtribenzyl; pentamethylcyclopentadienyltitaniumtriisopropyl; pentamethylcyclopentadienyltitaniumtribenzyl; pentamethylcyclopentadienyltitaniumdimethylmethoxide; pentamethylcyclopentadienyltitaniumdimethylchloride: bis(η⁵-2,4-dimethylpentadienyl)titanium; bis(η⁵-2,4-dimethylpentadienyl)titanium trimethylphosphine; bis(η⁵-2,4-dimethylpentadienyl)titanium triethylphosphine; octahydrofluorenyltitaniumtrimethyl; tetrahydroindenyltitaniumtrimethyl; tetrahydrofluorenyltitaniumtrimethyl; (ter-butylamido)(1,1-dimethyl-2,3,4,9,10-n-1,4,5,6,7,8-hexahydronaphthalenyl)dimethylsilanetitaniumdimethyl; (tert-butylamido)(1,1,2,3-tetramethyl-2,3,4,9,10-n-1,4,5,6,7,8-hexahydronaphthalenyl)dimethylsilanetitaniumdimethyl; (tert-butylamido)(tetramethyl-η⁵-cyclopentadienyl) dimethylsilanetitanium dibenzyl; (tert-butylamido)(tetramethyl-η⁵-cyclopentadienyl)dimethylsilanetitanium dimethyl; (tert-butylamido)(tetramethyl-η⁵-cyclopentadienyl)-1,2-ethanediyltitanium dimethyl; (tert-butylamido)(tetramethyl-η⁵-indenyl)dimethylsilanetitanium dimethyl; (tert-butylamido)(tetramethyl-η⁵-cyclopentadienyl)dimethylsilane titanium (III) 2-(dimethylamino)benzyl; (tert-butylamido)(tetramethyl-η⁵-cyclopentadienyl)dimethylsilanetitanium (III) allyl; (tert-butylamido)(tetramethyl-η⁵-cyclopentadienyl)dimethylsilanetitanium (III) 2,4-dimethylpentadienyl; (tert-butylamido)(tetramethyl-η⁵-cyclopentadienyl)dimethylsilanetitanium (II) 1,4-diphenyl-1,3-butadiene;

(tert-butylamido)(tetramethyl-η⁵-cyclopentadienyl)dimethylsilanetitanium (II) 1,3-pentadiene; (tert-butylamido)(2-methylindenyl)dimethylsilanetitanium (II) 1,4-diphenyl-1,3-butadiene; (tert-butylamido)(2-methylindenyl)dimethylsilanetitanium (II) 2,4-hexadiene; (tert-butylamido)(2-methylindenyl)dimethylsilanetitanium (IV) 2,3-dimethyl-1,3-butadiene; (tert-butylamido)(2-methylindenyl)dimethylsilanetitanium (IV) isoprene; (tert-butylamido)(2-methylindenyl)dimethylsilanetitanium (IV) 1,3-butadiene; (tert-butylamido)(2,3-dimethylindenyl)dimethylsilanetitanium (IV) 2,3-dimethyl-1,3-butadiene; (tert-butylamido)(2,3-dimethylindenyl)dimethylsilanetitanium (IV) isoprene; (tert-butylamido)(2,3-dimethylindenyl)dimethylsilanetitanium (IV) dimethyl; (tert-butylamido)(2,3-dimethylindenyl)dimethylsilanetitanium (IV) dibenzyl; (tert-butylamido)(2,3-dimethylindenyl)dimethylsilanctitanium (IV) 1,3-butadiene; (tert-butylamido)(2,3-dimethylindenyl)dimethylsilanetitanium (II) 1,3-pentadiene: (tert-butylamido)(2,3-dimethylindenyl)dimethylsilanetitanium (II) 1,4-diphenyl-1,3-butadiene; (tert-butylamido)(2-methylindenyl)dimethylsilanetitanium (II) 1,3-pentadiene; (tert-butylamido)(2-methylindenyl)dimethylsilanetitanium (IV) dimethyl; (tert-butylamido)(2-methylindenyl)dimethylsilanetitanium (IV) dibenzyl; (tert-butylamido)(2-methyl-4-phenylindenyl)dimethylsilanetitanium (II) 1,4-diphenyl-1,3-butadiene; (tert-butylamido)(2-methyl-4-phenylindenyl)dimethylsilanetitanium (II) 1,3-pentadiene; (tert-butylamido)(2-methyl-4-phenylindenyl)dimethylsilanetitanium (II) 2,4-hexadiene; (tert-butylamido)(tetramethyl-η⁵-cyclopentadienyl)dimethyl-silanetitanium (IV) 1,3-butadiene; (tert-butylamido)(tetramethyl-η⁵-cyclopentadienyl)dimethylsilanetitanium (IV) 2,3-dimethyl-1,3-butadiene; (tert-butylamido)(tetramethyl-η⁵-cyclopentadienyl)dimethylsilanetitanium (IV) isoprene; (tert-butylamido)(tetramethyl-η⁵-cyclopentadienyl)dimethyl-silanetitanium 1,4-dibenzyl-1,3-butadiene; (tert-butylamido)(tetramethyl-η⁵-cyclopentadienyl)dimethylsilanetitanium (II) 2,4-hexadiene; (tert-butylamido)(tetramethyl-η⁵-cyclopentadienyl)dimethyl-silanetitanium (II) 3-methyl-1,3-pentadiene; (tert-butylamido)(2,4-dimethylpentadien-3-(tert-butylamido)(6,6-yl)dimethylsilanetitaniumdimethyl; dimethylcyclohexadienyl)dimethylsilanetitaniumdimethyl; (tert-butylamido)(1,1-dimethyl-2,3,4,9,10-n-1,4,5,6,7,8-hexahydronaphthalen-4-yl)dimethylsilanetitaniumdimethyl; (tert-butylamido)(1,1,2,3-tetramethyl-2,3,4,9,10-n-1,4,5,6,7,8-hexabydronaphthalen-4-yl)dimethylsilanetitaniumdimethyl; (tert-butylamido)(tetramethyl-η⁵-cyclopentadienyl methylphenylsilanetitanium (IV) dimethyl; (tert-butylamido)(tetramethyl-η⁵-cyclopentadienyl methylphenylsilanetitanium (II) 1,4-diphenyl-1,3-butadiene; 1-(tert-butylamido)-2-(tetramethyl-η⁵-cyclopentadienyl)ethanediyltitanium (IV) dimethyl; 1-(tert-butylamido)-2-(tetramethyl-η⁵-cyclopentadienyl)ethanediyl-titanium (II) 1,4-diphenyl-1,3-butadiene;

Each of the illustrative cyclopentadienyl procatalyst may include zirconium or hafnium in place of the titanium metal centers of the cyclopentadienyl procatalyst.

Other procatalysts, especially procatalysts containing other Group IV metal-ligand complexes, will be apparent to those skilled in the art.

Both heterogeneous and homogeneous catalysts may be employed. Examples of heterogeneous catalysts include the well known Ziegler-Natta compositions, especially Group 4 metal halides supported on Group 2 metal halides or mixed halides and alkoxides and the well known chromium or vanadium based catalysts. Preferably, the catalysts for use herein are homogeneous catalysts comprising a relatively pure organometallic compound or metal complex. especially compounds or complexes based on metals selected from Groups 3-10 or the Lanthanide series of the Periodic Table of the Elements.

Metal complexes for use herein may be selected from Groups 3 to 15 of the Periodic Table of the Elements containing one or more delocalized, π-bonded ligands or polyvalent Lewis base ligands. Examples include metallocene, half-metallocene, constrained geometry, and polyvalent pyridylamine, or other polychelating base complexes. The complexes are generically depicted by the formula: MKₖXₓZ_{z}, or a dimer thereof, wherein M is a metal selected from Groups 3-15, preferably 3-10, more preferably 4-10, and most preferably Group 4 of the Periodic Table of the Elements; K independently at each occurrence is a group containing delocalized x-electrons or one or more electron pairs through which K is bound to M, said K group containing up to 50 atoms not counting hydrogen atoms, optionally two or more K groups may be joined together forming a bridged structure, and further optionally one or more K groups may be bound to Z, to X or to both Z and X; X independently at each occurrence is a monovalent, anionic moiety having up to 40 non-hydrogen atoms, optionally one or more X groups may be bonded together thereby forming a divalent or polyvalent anionic group, and, further optionally, one or more X groups and one or more/groups may be bonded together thereby forming a moiety that is both covalently bound to M and coordinated thereto; or two X groups together form a divalent anionic ligand group of up to 40 non-hydrogen atoms or together are a conjugated diene having from 4 to 30 non-hydrogen atoms bound by means of delocalized π-electrons to M, whereupon M is in the +2 formal oxidation state, and Z independently at each occurrence is a neutral. Lewis base donor ligand of up to 50 non-hydrogen atoms containing at least one unshared electron pair through which Z is coordinated to M; k is an integer from 0 to 3; x is an integer from 1 to 4; z is a number from 0 to 3; and the sum, k+x, is equal to the formal oxidation state of M.

Suitable metal complexes include those containing from 1 to 3 π-bonded anionic or neutral ligand groups, which may be cyclic or non-cyclic delocalized π-bonded anionic ligand groups. Exemplary of such π-bonded groups are conjugated or nonconjugated, cyclic or non-cyclic diene and dienyl groups, allyl groups, boratabenzene groups, phosphole, and arene groups. By the term “π-bonded” is meant that the ligand group is bonded to the transition metal by a sharing of electrons from a partially delocalized π-bond.

Each atom in the delocalized π-bonded group may independently be substituted with a radical selected from the group consisting of hydrogen, halogen, hydrocarbyl, halohydrocarbyl, hydrocarbyl-substituted heteroatoms wherein the heteroatom is selected from Group 14-16 of the Periodic Table of the Elements, and such hydrocarbyl-substituted heteroatom radicals further substituted with a Group 15 or 16 hetero atom containing moiety. In addition, two or more such radicals may together form a fused ring system, including partially or fully hydrogenated fused ring systems, or they may form a metallocycle with the metal. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. Suitable hydrocarbyl-substituted heteroatom radicals include mono-, di- and tri-substituted radicals of boron, silicon, germanium, nitrogen, phosphorus or oxygen wherein each of the hydrocarbyl groups contains from 1 to 20 carbon atoms. Examples include N,N-dimethylamino, pyrrolidinyl, trimethylsilyl, triethylsilyl, t-butyldimethylsilyl, methyldi(t-butyl)silyl, triphenylgermyl, and trimethylgermyl groups. Examples of Group 15 or 16 hetero atom containing moieties include amino, phosphino, alkoxy, or alkylthio moieties or divalent derivatives thereof, for example, amide, phosphide, alkyleneoxy or alkylenethio groups bonded to the transition metal or Lanthanide metal, and bonded to the hydrocarbyl group, π-bonded group, or hydrocarbyl-substituted heteroatom.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, phosphole, and boratabenzyl groups, as well as inertly substituted derivatives thereof, especially C1-10 hydrocarbyl-substituted or tris(C₁₋₁₀ hydrocarbyl)silyl-substituted derivatives thereof. Preferred anionic delocalized π-bonded groups are cyclopentadienyl. pentamethylcyclopentadienyl, tetramethylcyclopentadienyl, tetramethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, 1-indacenyl, 3-pyrrolidinoinden-1-yl, 3,4-(cyclopenta(1)phenanthren-1-yl, and tetrahydroindenyl.

More specifically this class of Group 4 metal complexes used according to the present invention includes “constrained geometry catalysts” corresponding to the formula:

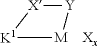

In the previous formula, M is titanium or zirconium, preferably titanium in the +2, +3, or +4 formal oxidation state; K¹ is a delocalized, π-bonded ligand group optionally substituted with from 1 to 5 R² groups, R² at each occurrence independently is selected from the group consisting of hydrogen, hydrocarbyl, silyl, germyl, cyano, halo and combinations thereof, said R² having up to 20 non-hydrogen atoms, or adjacent R² groups together form a divalent derivative (that is, a hydrocarbadiyl, siladiyl or germadiyl group) thereby forming a fused ring system, each X is a halo, hydrocarbyl, heterohydrocarbyl, hydrocarbyloxy or silyl group, said group having up to 20 non-hydrogen atoms, or two X groups together form a neutral C₅-30 conjugated diene or a divalent derivative thereof; x is 1 or 2; Y is —O—, —S—, —NR′—, —PR′—; and X′ is SiR′₂, CR′₂, SiR′₂SiR′₂, CR′₂CR′₂, CR′═CR′, CR′₂SiR′₂, or GeR′₂, wherein R′ independently at each occurrence is hydrogen or a group selected from silyl, hydrocarbyl, hydrocarbyloxy and combinations thereof, said R′ having up to 30 carbon or silicon atoms.

Specific examples of the foregoing constrained geometry metal complexes include compounds corresponding to the formula:

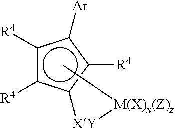

In the previous formula, Ar is an aryl group of from 6 to 30 atoms not counting hydrogen; R⁴ independently at each occurrence is hydrogen, Ar, or a group other than Ar selected from hydrocarbyl, trihydrocarbylsilyl, trihydrocarbylgermyl, halide, hydrocarbyloxy, trihydrocarbylsiloxy, bis(trihydrocarbylsilyl)amino, di(hydrocarbyl)amino, hydrocarbadiylamino, hydrocarbylimino, di(hydrocarbyl)phosphino, hydrocarbadiylphosphino, hydrocarbylsulfido, halo-substituted hydrocarbyl, hydrocarbyloxy-substituted hydrocarbyl, trihydrocarbylsilyl-substituted hydrocarbyl, trihydrocarbylsiloxy-substituted hydrocarbyl, bis(trihydrocarbylsilyl)amino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylenephosphino-substituted hydrocarbyl, or hydrocarbylsulfido-substituted hydrocarbyl, said R group having up to 40 atoms not counting hydrogen atoms, and optionally two adjacent R⁴ groups may be joined together forming a polycyclic fused ring group; M is titanium; X′ is SiR⁶₂, CR⁶₂, SiR⁶₂SIR⁶₂, CR⁶₂CR⁶₂, CR⁶═CR⁶, CR⁶₂SiR⁶₂, BR⁶, BR⁶L″, or GeR⁶₂; Y is —O—, —S—, —NR⁵—, —PR⁵—; —NR⁵₂, or —PR⁵₂; R⁵, independently at each occurrence is hydrocarbyl, trihydrocarbylsilyl, or trihydrocarbylsilylhydrocarbyl, said R⁵ having up to 20 atoms other than hydrogen, and optionally two R⁵ groups or R⁵ together with Y or Z form a ring system; R⁶, independently at each occurrence, is hydrogen, or a member selected from hydrocarbyl, hydrocarbyloxy, silyl, halogenated alkyl, halogenated aryl, —NR⁵₂, and combinations thereof, said R⁶ having up to 20 non-hydrogen atoms, and optionally, two R⁶ groups or R⁶ together with Z forms a ring system; Z is a neutral diene or a monodentate or polydentate Lewis base optionally bonded to R⁵, R⁶, or X; X is hydrogen, a monovalent anionic ligand group having up to 60 atoms not counting hydrogen, or two X groups are joined together thereby forming a divalent ligand group; x is 1 or 2; and z is 0, 1 or 2.

Additional examples of suitable metal complexes herein are polycyclic complexes corresponding to the formula:

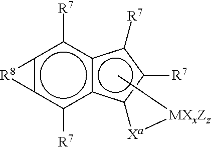

In the previous formula. M is titanium in the +2, +3 or +4 formal oxidation state; R⁷ independently at each occurrence is hydride, hydrocarbyl, silyl, germyl, halide, hydrocarbyloxy, hydrocarbylsiloxy, di(hydrocarbyl)amino, hydrocarbyleneamino, di(hydrocarbyl)phosphino, hydrocarbylene-phosphino, hydrocarbylsulfido, halo-substituted hydrocarbyl, hydrocarbyloxy-substituted hydrocarbyl, silyl-substituted hydrocarbyl, hydrocarbylsiloxy-substituted hydrocarbyl, hydrocarbylsilylamino-substituted hydrocarbyl, di(hydrocarbyl)amino-substituted hydrocarbyl, hydrocarbyleneamino-substituted hydrocarbyl, di(hydrocarbyl)phosphino-substituted hydrocarbyl, hydrocarbylene-phosphino-substituted hydrocarbyl, or hydrocarbylsulfido-substituted hydrocarbyl, said R⁷ group having up to 40 atoms not counting hydrogen, and optionally two or more of the foregoing groups may together form a divalent derivative; R⁸ is a divalent hydrocarbylene- or substituted hydrocarbylene group forming a fused system with the remainder of the metal complex, said R⁸ containing from 1 to 30 atoms not counting hydrogen; X^{a} is a divalent moiety, or a moiety comprising one π-bond and a neutral two electron pair able to form a coordinate-covalent bond to M, said X^{a} comprising boron, or a member of Group 14 of the Periodic Table of the Elements, and also comprising nitrogen, phosphorus, sulfur or oxygen; X is a monovalent anionic ligand group having up to 60 atoms exclusive of the class of ligands that are cyclic, delocalized, x-bound ligand groups and optionally two X groups together form a divalent ligand group; Z independently at each occurrence is a neutral ligating compound having up to 20 atoms; x is 0, 1 or 2; and z is zero or 1.

Additional examples of metal complexes that are usefully employed as catalysts are complexes of polyvalent Lewis bases, such as compounds corresponding to the formula:

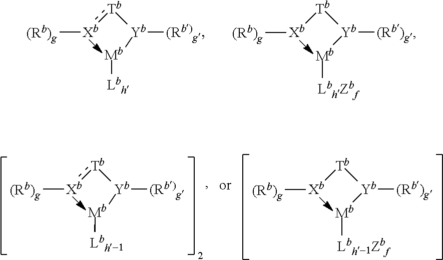

In the previous formulas, T^{b} is a bridging group, preferably containing 2 or more atoms other than hydrogen, X^{b} and Y^{b} are each independently selected from the group consisting of nitrogen, sulfur, oxygen and phosphorus; more preferably both X^{b} and Y^{b} are nitrogen, R^{b} and R^{b}, independently each occurrence are hydrogen or C₁₋₅₀ hydrocarbyl groups optionally containing one or more heteroatoms or inertly substituted derivative thereof. Non-limiting examples of suitable R^{b} and R^{b,} groups include alkyl, alkenyl, aryl, aralkyl, (poly)alkylaryl and cycloalkyl groups, as well as nitrogen, phosphorus, oxygen and halogen substituted derivatives thereof. Specific examples of suitable R^{b} and R^{b} groups include methyl, ethyl, isopropyl, octyl, phenyl, 2,6-dimethylphenyl, 2,6-di(isopropyl)phenyl, 2,4,6-trimethylphenyl, pentafluorophenyl, 3,5-trifluoromethylphenyl, and benzyl; g and g′ are each independently 0 or 1; M^{b} is a metallic element selected from Groups 3 to 15, or the Lanthanide series of the Periodic Table of the Elements. Preferably, M^{b} is a Group 3-13 metal, more preferably M^{b} is a Group 4-10 metal; L^{b} is a monovalent, divalent, or trivalent anionic ligand containing from 1 to 50 atoms, not counting hydrogen. Examples of suitable L^{b} groups include halide; hydride; hydrocarbyl, hydrocarbyloxy; di(hydrocarbyl)amido, hydrocarbyleneamido, di(hydrocarbyl)phosphido; hydrocarbylsulfido; hydrocarbyloxy, tri(hydrocarbylsilyl)alkyl; and carboxylates. More preferred L^{b} groups are C1-20 alkyl, C7-20 aralkyl, and chloride; h and h′ are each independently an integer from 1 to 6, preferably from 1 to 4, more preferably from 1 to 3, and j is 1 or 2, with the value h×j selected to provide charge balance; Z^{b} is a neutral ligand group coordinated to M^{b}, and containing up to 50 atoms not counting hydrogen. Preferred Z^{b} groups include aliphatic and aromatic amines, phosphines, and ethers, alkenes, alkadienes, and inertly substituted derivatives thereof. Suitable inert substituents include halogen, alkoxy, aryloxy, alkoxycarbonyl, aryloxycarbonyl, di(hydrocarbyl)amine, tri(hydrocarbyl)silyl, and nitrile groups. Preferred Z^{b} groups include triphenylphosphine, tetrahydrofuran, pyridine, and 1,4-diphenylbutadiene; f is an integer from 1 to 3; two or three of T^{b}, R^{b} and R^{b′} may be joined together to form a single or multiple ring structure; h is an integer from 1 to 6, preferably from 1 to 4, more preferably from 1 to 3;

In one embodiment, it is preferred that R^{b} have relatively low steric hindrance with respect to X^{b}. In this embodiment, most preferred R^{b} groups are straight chain alkyl groups, straight chain alkenyl groups, branched chain alkyl groups wherein the closest branching point is at least 3 atoms removed from X^{b}, and halo, dihydrocarbylamino, alkoxy or trihydrocarbylsilyl substituted derivatives thereof. Highly preferred R^{b} groups in this embodiment are C1-8 straight chain alkyl groups.

At the same time, in this embodiment R^{b′} preferably has relatively high steric hindrance with respect to Y^{b}. Non-limiting examples of suitable R^{b′} groups for this embodiment include alkyl or alkenyl groups containing one or more secondary or tertiary carbon centers, cycloalkyl, aryl, alkaryl, aliphatic or aromatic heterocyclic groups, organic or inorganic oligomeric, polymeric or cyclic groups, and halo, dihydrocarbylamino, alkoxy or trihydrocarbylsilyl substituted derivatives thereof. Preferred R^{b′} groups in this embodiment contain from 3 to 40, more preferably from 3 to 30, and most preferably from 4 to 20 atoms not counting hydrogen and are branched or cyclic. Examples of preferred T^{b} groups are structures corresponding to the following formulas:

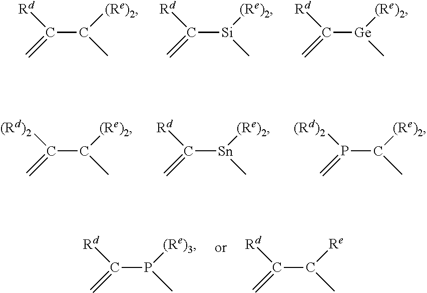

wherein

Each R^{d} is C1-10 hydrocarbyl group, preferably methyl, ethyl, n-propyl, i-propyl, t-butyl, phenyl, 2,6-dimethylphenyl, benzyl, or tolyl. Each R^{e} is C1-10 hydrocarbyl, preferably methyl, ethyl, n-propyl, i-propyl, t-butyl, phenyl, 2,6-dimethylphenyl, benzyl, or tolyl. In addition, two or more R^{d} or R^{e} groups, or mixtures of Rd and Re groups may together form a divalent or polyvalent derivative of a hydrocarbyl group, such as, 1,4-butylene, 1,5-pentylene, or a cyclic ring, or a multicyclic fused ring, polyvalent hydrocarbyl- or heterohydrocarbyl-group, such as naphthalene-1,8-diyl.

Suitable examples of the foregoing polyvalent Lewis base complexes include:

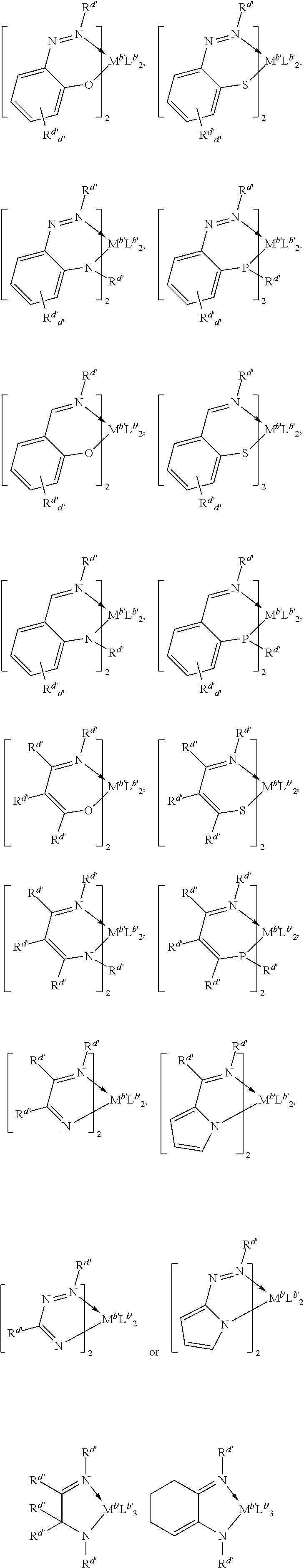

In the previous formula, R^{d′} at each occurrence is independently selected from the group consisting of hydrogen and (C₁-C₅₀)hydrocarbyl groups optionally containing one or more heteroatoms, or inertly substituted derivative thereof, or further optionally, two adjacent R^{d′} groups may together form a divalent bridging group; d′ is 4; M^{b}′ is a Group 4 metal, preferably titanium or hafnium, or a Group 10 metal, preferably Ni or Pd; L^{b′} is a monovalent ligand of up to 50 atoms not counting hydrogen, preferably halide or hydrocarbyl, or two L^{b′} groups together are a divalent or neutral ligand group, preferably a (C₂-C₅₀)hydrocarbylene, hydrocarbadiyl or diene group.

The polyvalent Lewis base complexes for use in the present invention especially include Group 4 metal derivatives, especially hafnium derivatives of hydrocarbylamine substituted heteroaryl compounds corresponding to the formula:

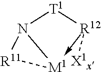

In the previous formula, R¹¹ is selected from alkyl, cycloalkyl, heteroalkyl. cycloheteroalkyl, aryl, and inertly substituted derivatives thereof containing from 1 to 30 atoms not counting hydrogen or a divalent derivative thereof; T¹ is a divalent bridging group of from 1 to 41 atoms other than hydrogen, preferably 1 to 20 atoms other than hydrogen, and most preferably a mono- or di-C1-20 hydrocarbyl substituted methylene or silane group; and R¹² is a (C₅-C₂₀)heteroaryl group containing Lewis base functionality, especially a pyridin-2-yl- or substituted pyridin-2-yl group or a divalent derivative thereof; M¹ is a Group 4 metal, preferably hafnium; X¹ is an anionic, neutral or dianionic ligand group; x′ is a number from 0 to 5 indicating the number of such X¹ groups; and bonds, optional bonds and electron donative interactions are represented by lines, dotted lines and arrows respectively.

Suitable complexes are those wherein ligand formation results from hydrogen elimination from the amine group and optionally from the loss of one or more additional groups, especially from R¹². In addition, electron donation from the Lewis base functionality, preferably an electron pair, provides additional stability to the metal center. Suitable metal complexes correspond to the formula:

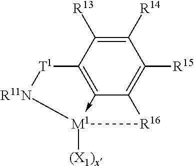

In the previous formula, M¹, X¹, x′, R¹¹ and T¹ are as previously defined, R¹³, R¹⁴, R¹⁵ and R¹⁶ are hydrogen, halo, or an alkyl, cycloalkyl, heteroalkyl, heterocycloalkyl, aryl, or silyl group of up to 20 atoms not counting hydrogen, or adjacent R¹³, R¹⁴, R¹⁵ or R¹⁶ groups may be joined together thereby forming fused ring derivatives, and bonds, optional bonds and electron pair donative interactions are represented by lines, dotted lines and arrows respectively.

Suitable examples of the foregoing metal complexes correspond to the formula:

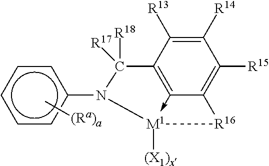

In the previous formula, M¹, X¹, and x′ are as previously defined, R¹³, R¹⁴, R¹⁵ and R¹⁶ are as previously defined, preferably R¹³, R¹⁴, and R¹⁵ are hydrogen, or (C₁-C₄)alkyl, and R¹⁶ is C₆-20 aryl, most preferably naphthalenyl; Ra independently at each occurrence is (C₁-C₄)alkyl, and a is 1-5, most preferably Ra in two ortho- positions to the nitrogen is isopropyl or t-butyl; R¹⁷ and R¹⁸ independently at each occurrence are hydrogen, halogen, or a (C₁-C₂₀)alkyl or aryl group, most preferably one of R¹⁷ and R¹⁸ is hydrogen and the other is a (C₆-C₂₀)aryl group, especially 2-isopropyl, phenyl or a fused polycyclic aryl group, most preferably an anthracenyl group, and bonds, optional bonds and electron pair donative interactions are represented by lines, dotted lines and arrows respectively.

Exemplary metal complexes for use herein as catalysts correspond to the formula:

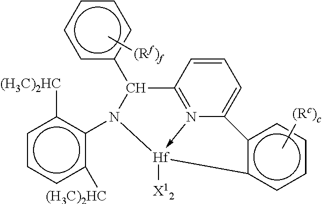

In the formula, X¹ at each occurrence is halide, N,N-dimethylamido, or C₁-4 alkyl, and preferably at each occurrence X¹ is methyl; R^{f} independently at each occurrence is hydrogen, halogen, (C₁-C₂₀)alkyl, or (C₆-C₂₀)aryl, or two adjacent R^{f} groups are joined together thereby forming a ring, and f is 1-5; and Re independently at each occurrence is hydrogen, halogen, (C₁-C₂₀)alkyl, or (C₆-C₂₀)aryl, or two adjacent R^{c} groups are joined together thereby forming a ring, and c is 1-5.

Suitable examples of metal complexes for use as catalysts include the following formulas:

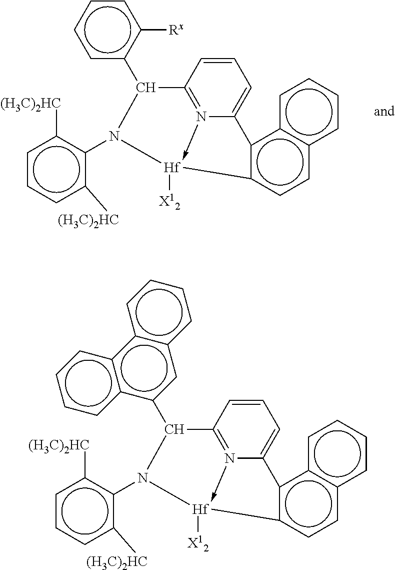

In the previous formula, R^{x} is (C₁-C₄)alkyl or cycloalkyl, preferably methyl, isopropyl, t-butyl or cyclohexyl; and X¹ at each occurrence is halide, N,N-dimethylamido, or (C₁-C₄)alkyl, preferably methyl.

Examples of metal complexes usefully employed as catalysts according to the present invention include:

[N-(2,6-di(1-methylethyl)phenyl)amido)(o-tolyl)(α-naphthalen-2-diyl(6-pyridin-2-diyl)methane)]hafnium dimethyl;

[N-(2,6-di(1-methylethyl)phenyl)amido)(o-tolyl)(α-naphthalen-2-diyl(6-pyridin-2-diyl)methane)]hafnium di(N,N-dimethylamido);

[N-(2,6-di(1-methylethyl)phenyl)amido)(o-tolyl)(α-naphthalen-2-diyl(6-pyridin-2-diyl)methane)]hafnium dichloride;

[N-(2,6-di(1-methylethyl)phenyl)amido)(2-isopropylphenyl)(α-naphthalen-2-diyl(6-pyridin-2-diyl)methane)]hafnium dimethyl;

[N-(2,6-di(1-methylethyl)phenyl)amido)(2-isopropylphenyl)(α-naphthalen-2-diyl(6-pyridin-2-diyl)methane)]hafnium di(N,N-dimethylamido);

[N-(2,6-di(1-methylethyl)phenyl)amido)(2-isopropylphenyl)(α-naphthalen-2-diyl(6-pyridin-2-diyl)methane)]hafnium dichloride;

[N-(2,6-di(1-methylethyl)phenyl)amido)(phenanthren-5-yl)(α-naphthalen-2-diyl(6-pyridin-2-diyl)methane)]hafhium dimethyl;

[N-(2,6-di(1-methylethyl)phenyl)amido)(phenanthren-5-yl)(α-naphthalen-2-diyl(6-pyridin-2-diyl)methane)]hafhium di(N,N-dimethylamido); and [N-(2,6-di(1-methylethyl)phenyl)amido)(phenanthren-5-yl)(α-naphthalen-2-diyl(6-pyridin-2-diyl)methane)]hafnium dichloride.

Under the reaction conditions used to prepare the metal complexes used in the present disclosure, the hydrogen of the 2-position of the a-naphthalene group substituted at the 6-position of the pyridin-2-yl group is subject to elimination, thereby uniquely forming metal complexes wherein the metal is covalently bonded to both the resulting amide group and to the 2-position of the α-naphthalenyl group, as well as stabilized by coordination to the pyridinyl nitrogen atom through the electron pair of the nitrogen atom.

Further procatalysts that are suitable include imidazole-amine compounds corresponding to those disclosed in WO 2007/130307A2, WO 2007/130306A2, and U.S. Patent Application Publication No. 20090306318A1, which are incorporated herein by reference in their entirety. Such imidazole-amine compounds include those corresponding to the formula:

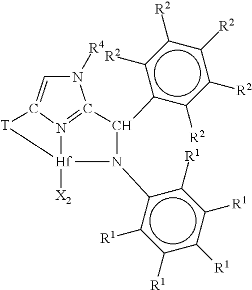

In the imidazole-amine compounds, X independently each occurrence is an anionic ligand, or two X groups together form a dianionic ligand group, or a neutral diene; T is a cycloaliphatic or aromatic group containing one or more rings; R¹ independently each occurrence is hydrogen, halogen, or a univalent, polyatomic anionic ligand, or two or more R¹ groups are joined together thereby forming a polyvalent fused ring system; R² independently each occurrence is hydrogen, halogen, or a univalent, polyatomic anionic ligand, or two or more R² groups are joined together thereby forming a polyvalent fused ring system; and R⁴ is hydrogen, alkyl, aryl, aralkyl, trihydrocarbylsilyl, or trihydrocarbylsilylmethyl of from 1 to 20 carbons.

Further examples of such imidazole-amine compounds include but are not limited to the following:

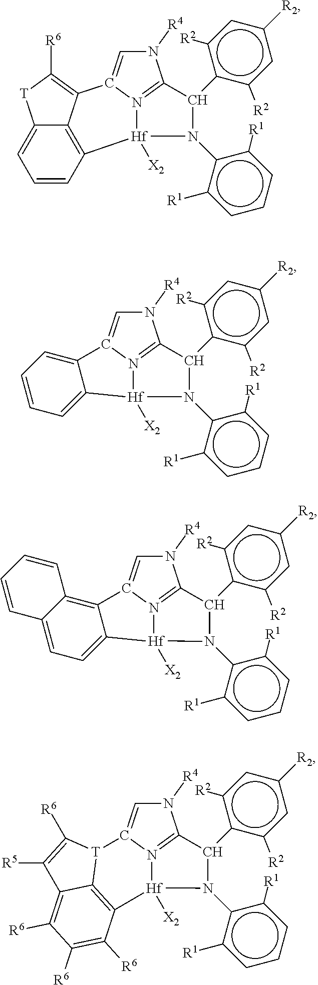

In the imidazole-amine compounds, R¹ independently each occurrence is a (C₃-C₁₂)alkyl group wherein the carbon attached to the phenyl ring is secondary or tertiary substituted; R² independently each occurrence is hydrogen or a (C₁-C₂)alkyl group; R⁴ is methyl or isopropyl; R⁵ is hydrogen or C₁-6 alkyl; R⁶ is hydrogen, (C₁-C₆)alkyl or cycloalkyl, or two adjacent R⁶ groups together form a fused aromatic ring; T′ is oxygen, sulfur, or a (C₁-C₂₀)hydrocarbyl-substituted nitrogen or phosphorus group; T″ is nitrogen or phosphorus; and X is methyl or benzyl.

### Cocatalyst Component

The catalyst system comprising a Group IV metal-ligand complex may be rendered catalytically active by any technique known in the art for activating metal-based catalysts of olefin polymerization reactions. For example, the procatalyst according to a Group IV metal-ligand complex may be rendered catalytically active by contacting the complex to an activating co-catalyst or combining the complex with an activating co-catalyst. Additionally, the Group IV metal-ligand complex includes both a neutral procatalyst form, and a positively-charged catalytic form, which may be positively charged due to the loss of a monoanionic ligand, such as a benzyl, phenyl, or methyl. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activating co-catalysts include Group 13 metal compounds containing (C₁-C₂₀)hydrocarbyl substituents as described herein. In some embodiments, Group 13 metal compounds are tri((C₁-C₂₀)hydrocarbyl)-substituted-aluminum or tri((C₁-C₂₀)hydrocarbyl)-boron compounds. In other embodiments, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof. In further embodiments. Group 13 metal compounds are tris(fluoro-substituted phenyl)boranes, tris(pentafluorophenyl)borane. In some embodiments, the activating co-catalyst is a tri((C₁-C₂₀)hydrocarbyl)ammonium tetra((C₁-C₂₀)hydrocarbyl)borate (e.g. bis(octadecyl)methylammonium tetrakis(pentafluorophenyl)borate). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbyIN(H)₃⁺, or N(H)₄⁺, wherein each (C₁-C₂₀)hydrocarbyl, when two or more are present, may be the same or different.

Combinations of neutral Lewis acid activating co-catalysts include mixtures comprising a combination of a tri((C₁-C₄)alkyl)aluminum and a halogenated tri((C₆-C₁₈)aryl)boron compound, especially a tris(pentafluorophenyl)borane. Other embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex): (tris(pentafluorophenylborane): (alumoxane) [e.g., (Group IV metal-ligand complex) :(tris(pentafluorophenylborane):(alumoxane)] are from 1:1:1 to 1:10:5000, in other embodiments, from 1:1:1.5 to 1:5:10.

The catalyst system comprising a Group IV metal-ligand complex may be activated to form an active catalyst composition by combination with one or more cocatalysts, for example, a cation forming cocatalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to modified methyl aluminoxane (MMAO), bis(hydrogenated tallow alkyl)methyl ammonium tetrakis(pentafluorophenyl)borate, and combinations thereof.

In some embodiments, more than one of the foregoing activating co-catalysts may be used in combination with each other. A specific example of a co-catalyst combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more Group IV metal-ligand complexes to total number of moles of one or more of the activating co-catalysts is from 1:10,000 to 100:1. In some embodiments, the ratio is at least 1:5000, in some other embodiments, at least 1:1000; and 10:1 or less, and in some other embodiments, 1:1 or less. When an alumoxane alone is used as the activating co-catalyst, preferably the number of moles of the alumoxane that are employed is at least 100 times the number of moles of the Group IV metal-ligand complex. When tris(pentafluorophenyl)borane alone is used as the activating co-catalyst, in some other embodiments, the number of moles of the tris(pentafluorophenyl)borane that are employed to the total number of moles of one or more Group IV metal-ligand complexes from 0.5:1 to 10:1, from 1:1 to 6:1, or from 1:1 to 5:1. The remaining activating co-catalysts are generally employed in approximately mole quantities equal to the total mole quantities of one or more Group IV metal-ligand complexes.

In some embodiments, the co-catalysts may include tri(hydrocarbyl)aluminum compounds having from 1 to 10 carbons in each hydrocarbyl group, an oligomeric or polymeric alumoxane compound, di(hydrocarbyl)(hydrocarbyloxy)aluminums compound having from 1 to 20 carbons in each hydrocarbyl or hydrocarbyloxy group, or mixtures of the foregoing compounds. These aluminum compounds are usefully employed for their beneficial ability to scavenge impurities such as oxygen, water, and aldehydes from the polymerization mixture.

The di(hydrocarbyl) (hydrocarbyloxy)aluminum compounds that may be used in conjunction with the activators described in this disclosure correspond to the formula T¹₂AlOT² or T¹₁Al(OT²)₂ wherein T¹ is a secondary or tertiary (C₃-C₆)alkyl, such as isopropyl, isobutyl or tert-butyl; and T² is a alkyl substituted (C₆-C₃₀)aryl radical or aryl substituted (C₁-C₃₀)alkyl radical, such as 2,6-di(fert-butyl)-4-methylphenyl, 2,6-di(tert-butyl)-4-methylphenyl, 2,6-di(tert-butyl)-4-methyltolyl, or 4-(3′,5′-di-ter-butyltolyl)-2,6-di-tert-butylphenyl.

Additional examples of aluminum compounds include [C₆]trialkyl aluminum compounds, especially those wherein the alkyl groups are ethyl, propyl, isopropyl, n-butyl, isobutyl, pentyl, neopentyl, or isopentyl, dialkyl(aryloxy)aluminum compounds containing from 1-6 carbons in the alkyl group and from 6 to 18 carbons in the aryl group (especially (3.5-di(t-butyl)-4-methylphenoxy)diisobutylaluminum), methylalumoxane, modified methylalumoxane and diisobutylalumoxane.

In the catalyst systems according to embodiments of this disclosure, the molar ratio of the ionic metallic activator complex to Group IV metal-ligand complex may be from 1:10,000 to 1000:1, such as, for example, from 1:5000 to 100:1, from 1:100 to 100:1 from 1:10 to 10:1, from 1:5 to 1:1, or from 1.25:1 to 1:1. The catalyst systems may include combinations of one or more ionic metallic activator complexes described in this disclosure.

### Ethylene-Based Polymer

The catalytic systems described in the preceding paragraphs are utilized in the polymerization of olefins. Ethylene-based polymers, for example homopolymers and/or interpolymers (including copolymers) of ethylene and optionally one or more co-monomers such as α-olefins, may comprise from at least 50 mole percent (mol %) monomer units derived from ethylene. All individual values and subranges encompassed by “from at least 50 mol %” are disclosed herein as separate embodiments; for example, the ethylene-based polymers, homopolymers and/or interpolymers (including copolymers) of ethylene and optionally one or more co-monomers such as α-olefins may comprise at least 60 mol % monomer units derived from ethylene; at least 70 mol % monomer units derived from ethylene; at least 80 mol % monomer units derived from ethylene; or from 50 to 100 mol % monomer units derived from ethylene; or from 80 to 100 mol % units derived from ethylene.

In some embodiments, the ethylene-based polymers may comprise at least 90 mole percent units derived from ethylene. All individual values and subranges from at least 90 mole percent are included herein and disclosed herein as separate embodiments. For example, the ethylene-based polymers may comprise at least 93 mole percent units derived from ethylene; at least 96 mole percent units; at least 97 mole percent units derived from ethylene; or in the alternative, from 90 to 100 mole percent units derived from ethylene; from 90 to 99.5 mole percent units derived from ethylene; or from 97 to 99.5 mole percent units derived from ethylene.

In some embodiments of the ethylene-based polymer, the ethylene-based polymers may comprise an amount of (C₃-C₂₀)α-olefin. The amount of (C₃-C₂₀)α-olefin is less than 50 mol %. In some embodiments, the ethylene-based polymer may include at least 0.5 mol % to 25 mol % of (C₃-C₂₀)α-olefin; and in further embodiments, the ethylene-based polymer may include at least 5 mol % to 10 mol %. In some embodiments, the additional α-olefin is 1-octene.

Any conventional polymerization process, in combination with a catalyst system according to this disclosure may be used to produce the ethylene-based polymers. Such conventional polymerization processes include, but are not limited to, solution polymerization processes, gas-phase polymerization processes, slurry-phase polymerization processes, and combinations thereof using one or more conventional reactors such as loop reactors, isothermal reactors, fluidized-bed gas-phase reactors, stirred-tank reactors, batch reactors in parallel, series, or any combinations thereof, for example.

In one embodiment, ethylene-based polymer may be produced via solution polymerization in a dual reactor system, for example a dual-loop reactor system, wherein ethylene and optionally one or more α-olefins are polymerized in the presence of the catalyst system, as described herein, and optionally one or more co-catalysts. In another embodiment, the ethylene-based polymer may be produced via solution polymerization in a dual reactor system. for example a dual-loop reactor system, wherein ethylene and optionally one or more o-olefins are polymerized in the presence of the catalyst system in this disclosure, and as described herein, and optionally one or more other catalysts. The catalyst system, as described herein, can be used in the first reactor, or second reactor, optionally in combination with one or more other catalysts. In one embodiment, the ethylene-based polymer may be produced via solution polymerization in a dual reactor system, for example a dual-loop reactor system, wherein ethylene and optionally one or more α-olefins are polymerized in the presence of the catalyst system, as described herein, in both reactors.

In another embodiment, the ethylene-based polymer may be produced via solution polymerization in a single reactor system, for example a single-loop reactor system, in which ethylene and optionally one or more α-olefins are polymerized in the presence of the catalyst system, as described within this disclosure.

The polymer process may further include incorporating one or more additives. Such additives include, but are not limited to, antistatic agents, color enhancers, dyes, lubricants, pigments, primary antioxidants, secondary antioxidants, processing aids, UV stabilizers, and combinations thereof. The ethylene-based polymers may contain any amounts of additives. The ethylene-based polymers may comprise from about 0 to about 10 percent by weight of the total amount of such additives, based on the weight of the ethylene-based polymers and the one or more additives. The ethylene-based polymers may further comprise fillers, which may include, but are not limited to, organic or inorganic fillers. The ethylene-based polymers may contain from about 0) to about 20 weight percent fillers such as, for example, calcium carbonate, talc, or Mg(OH)₂, based on the combined weight of the ethylene-based polymers and all additives or fillers. The ethylene-based polymers may further be blended with one or more polymers to form a blend.

In some embodiments, the polymer resulting from the catalyst system that includes the metal-ligand complex and the ionic metallic activator complex has a molecular-weight distribution (MWD) from 1 to 25, where MWD is defined as Mw/Mn with Mw being a weight-average molecular weight and Mn being a number-average molecular weight. In other embodiments, the polymers resulting from the catalyst system have a MWD from 1 to 6. Another embodiment includes a MWD from 1 to 3; and other embodiments include MWD from 1.5 to 2.5.

### Batch Reactor Procedure

A 2 L Parr reactor was used for all polymerization experiments. The reactor was heated via an electrical heating mantle and was cooled via an internal serpentine cooling coil containing water. Both the reactor and the heating/cooling system were controlled and monitored by a Camile TG process computer. All chemicals used for polymerization or catalyst makeup were run through purification columns. 1-octene, toluene, and Isopar-E (a mixed alkanes solvent available from ExxonMobil, Inc.) were passed through 2 columns, the first containing A2 alumina, and the second containing Q5 reactant (available from Engelhard Chemicals Inc.). Ethylene gas was passed through 2 columns, the first containing A204 alumina and activated 4 Å molecular sieves. the second containing Q5 reactant. Hydrogen gas was passed through Q5 reactant and A2 alumina. Nitrogen gas was passed through a single column containing A204 alumna, activated 4 Å molecular sieves and Q5 reactant. Catalyst and cocatalyst (also called the activator) solutions were handled in a nitrogen-filled glovebox.

The load column was filled with Isopar-E to the load setpoints by use of an Ashcroft differential pressure cell, and the material was transferred into the reactor. 1-octene was measured by syringe and added via the shot tank due to low amount used. Once complete, the reactor immediately begins heating toward the reaction setpoint. Scavenger (MMAO-3A, 20 μmol) solution was added to the reactor via the shot tank once 25 degrees prior to the setpoint. Next, chain transfer agent (typically tri-n-octylaluminum) was added to the reactor via the shot tank. At 10 degrees prior to reaching the setpoint, ethylene was added to the specified pressure as monitored via a micro-motion flow meter. Finally, at this same time, dilute toluene solutions of catalyst and cocatalyst (as specified) were mixed, transferred to the shot tank, and added to the reactor to begin the polymerization reaction. The polymerization conditions were typically maintained with supplemental ethylene added on demand to maintain the specified pressure until an ethylene uptake of 20 g was achieved. Exothermic heat was continuously removed from the reaction vessel via the internal cooling coil. After the desired ethylene uptake was reached, the agitator was then stopped and the bottom dump valve opened to empty reactor contents into a clean dump pot that had been stored in a 130° C. oven for greater than 60 minutes prior to use in order to drive off any excess water absorbed by the metal surface. The resulting solution was removed from the reactor without the addition of the typical antioxidant package (Irganox 1010 and Irgafos 168). Once the contents of the reactor were emptied into the dump pot, the normal flow of nitrogen inserting was switched to argon, via a ball valve. The argon flowed for a calculated period of time to allow five exchanges of the volume of gas in the pot. When the argon inserting was complete, the dump pot was lowered from its fixture, and a secondary lid with inlet and outlet valves was sealed to the top of the pot. The pot was then inerted with argon for an additional five exchanges of gas, via a supply line and inlet/outlet valves. When complete, the valves were closed. The pot was then transferred to a glove box without the contents coming into contact with the outside atmosphere. Then, the contents of the dump pot were transferred to a 1 L glass jar for storage.

Between polymerization runs, at least one wash cycle was conducted in which Isopar-E (850 g) was added and the reactor was heated to a setpoint between 160° C. and 190° C. The reactor was then emptied of the heated solvent immediately before beginning a new polymerization run.

### EXAMPLES

Examples 1 to 5 include a synthetic step to produce the end-functionalized polyolefin. One or more features of the present disclosure are illustrated in view of the examples as follows:

Example 1—Synthesis of polymeryl aluminum via aluminum chain-transfer agents

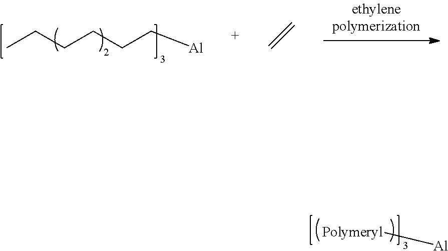

To synthesize the (polymeryl)Al, ethylene and optionally octene were polymerized in the presence of Al(octyl)₃ and Procatalyst 1. The aluminum functioned as a chain-transfer agent that resulted in the formation of (polymeryl)Al.

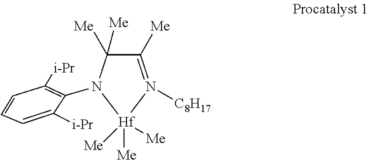

Procatalyst 1 can be synthesized according to Macromolecules (Washington, DC, United States) (2010), 43(19), 7903-7904 https://doi.org/10.1021/ma101544n

The (polymeryl)Al compound of Example 1 was synthesized according to the general procedure under to following conditions:

| | |
|---|---|
| Temperature (° C.) | 100 |
| Pressure (psig) | 142.4 |
| Isopar E (g) | 600.9 |
| Octene (g) | 0.00 |
| Catalyst | Procatalyst 1 |
| Catalyst (μmol) | 0.8 |
| Activator | bis(hydrogenated tallow |
| | alkyl)methyl ammonium |
| | tetrakis(pentafluorophenyl)borate |
| Activator (μmol) | 0.96 |
| Scavenger | MMAO-3A |
| Scavenger (μmol) | 20 |
| Chain Transfer Agent | tri(n-octylaluminum) |
| Chain Transfer Agent | 6,632 |
| (μmol) | |
| Actual Run Time (min) | 25.0 |
| Ethylene Uptake (g) | 20.20 |
| Yield (polymeryl)Al (g) | 22.6 |

An aliquot of the (polymeryl)Al produced in Example 1 was quenched to determine the percent of functionality and molecular weight; and it was determined that the weight average molecular weight GPC) was 1,901 (g/mol), the number average molecular weight was 1,264, the weight percent of polymeryl aluminum in the mixture (prior to quenching) was 4.12%, and live aluminum chains was 100%.

Example 2—Synthesis of the polyolefin-SO₂Cl (sulfonyl chloride functionalized polyolefin)

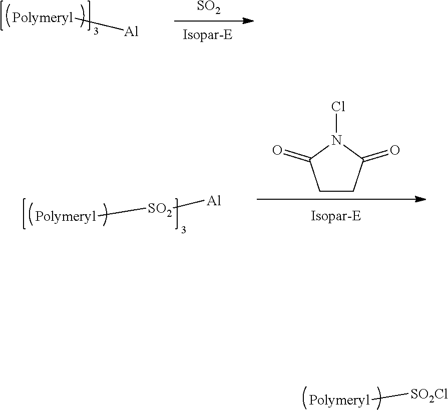

In an N₂ filled glovebox, 24.3 g of a (polymeryl)Al slurry from Example 1 in ISOPAR-E was added by weight to a 3-neck, 100 mL glass round bottom reactor flask equipped with a stir bar, a PTFE tube gas inlet sealed with a quick connect adaptor, a reflux condenser assembly sealed with a gas outlet valve, and a rubber septum. Once fully sealed, the flask was removed from the glovebox and securely clamped on the heating block on the stir plate. Under N₂ purge, the mixture was heated to 130° C. The mix was maintained at 130° C. for ˜5 minutes, until completely homogenous, then the gas purge was switched to SO₂. SO₂ was bubbled through the reaction for 30 minutes at 130° C. Heating of the flask was stopped, and the reaction was allowed to cool under a slow SO₂ flow until most of the solid precipitated from the reaction. The gas flow was switched to N₂, and the system was purged for 5 minutes. A suspension of N-chlorosuccinimide in toluene (˜3 mL) was added to the reaction flask via syringe. The flask was reheated to 130° C. Once all solid had dissolved, the yellow solution was stirred for 30 minutes at 130° C. After 30 minutes, heating was stopped, and the reaction was allowed to cool under N₂. Once cooled to ˜60° C. the reaction slurry was poured into a stirred beaker of MeOH (˜200 mL) to precipitate the polymer product. The MeOH suspension was stirred for 30 minutes, then the white solid collected by vacuum filtration, washed with additional MeOH, and dried overnight in a 50° C. vacuum oven. 1.03 g of solid was recovered.

¹H NMR analysis revealed a 4:1 mixture of functionalized PE-SO₂Cl and unfunctionalized polyethylene (PE-H). ¹H NMR (500 MHz, tetrachloroethane-d2, 110° C.): δ 3.78-3.66 (m. 2H, PE-SO₂Cl), 2.17-2.02 (m. 2H, PE-SO₂Cl), 1.37 (s. 246H, PE-SO2Cl+PE-H), 0.98 (t. J=6.8 Hz, 4H, PE-SO₂Cl+PE-H).

### Example 3—Synthesis of sulfonate end-functionalized polyolefin

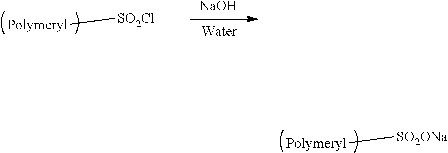

PE-sulfonyl chloride from Example 2 (1.4 g. 80% mono-functionalized) and aqueous NaOH (100 mL, 5 M) were added to a 250 mL round bottom flask equipped with a stir bar and reflux condenser. The suspension was heated to reflux with vigorous stirring (1000 rpm). The mixture was refluxed for 24 hours, then cooled to room temperature. The solids were collected by vacuum filtration and washed generously with water. The solids were dried in a vacuum oven at 50° C. overnight to give a fine white powder (1.3 g, 92%). ¹H NMR analysis revealed complete conversion of PE-SO₂Cl to PE-SO₃Na.

¹H NMR (500 MHz, 9:1 tetrachloroethane-d₂:DMSO-d₆, 110° C.): δ 2.72-2.54 (m, 2H, PE-SO₃Na), 1.71-1.60 (m, 2H, PE-SO₃Na), 1.43-0.88 (m, 240H, PE-SO₃Na+PE-H), 0.79 (t, J=6.7 Hz, 4.85H, PE-SO₃Na+PE-H).

### Example 4Synthesis of End Reactive Polymer via Aluminum Chain-Transfer Agents

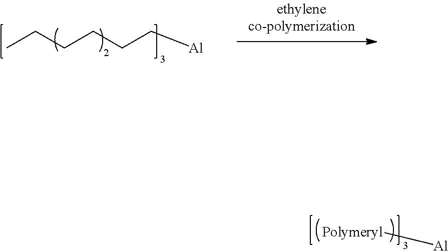

To synthesize the (polymeryl)Al, ethylene and octene were polymerized in the presence of Al(octyl)₃ and Procatalyst 1. The aluminum reagent functioned as a chain-transfer agent that resulted in the formation of polymeryl aluminum species.

The (polymeryl)Al compound of Example 4 were synthesized according to the general procedure under to following conditions:

| | |
|---|---|
| Temperature (° C.) | 100 |
| Pressure (psig) | 123.0 |
| Isopar E (g) | 593.9 |
| Octene (g) | 6.0 |
| Catalyst | Procatalyst 1 |
| Catalyst (μmol) | 0.4 |
| Activator | bis(hydrogenated tallow |
| | alkyl)methyl ammonium |
| | tetrakis(pentafluorophenyl)borate |
| Activator (μmol) | 0.48 |
| Scavenger | MMAO-3A |
| Scavenger (μmol) | 20 |
| Chain Transfer Agent | Tri(n-octyl)aluminum |
| Chain Transfer Agent | 1,305 |
| (μmol) | |
| Actual Run Time (min) | 7.5 |
| Ethylene Uptake (g) | 20.15 |
| Yield (polymeryl)Al (g) | 22.0 |

An aliquot of the (polymeryl)Al produced in Example 4 was quenched to determine the percent of functionality and molecular weight; and it was determined that a molecular weight per chain (GPC) was 11,277 (g/mol), molecular number was 6,096 (g/mol), octene incorporation was 1.3 mol %, a weight percent of (polymeryl)Al in the mixture (prior to quenching) was 3.76%. and live aluminum chains was 100%.

Example 5—Synthesis of the polyolefin-SO₂Cl (sulfonyl chloride functionalized polyolefin.

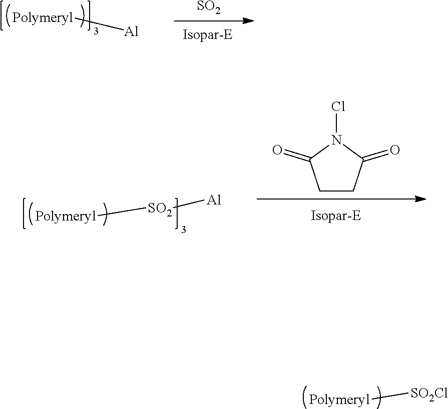

In an N₂ filled glovebox, 26.6 g of a polymeryl aluminum slurry from Example 4 in Isopar-E was added by weight to a 3-neck, 100 mL glass round bottom reactor flask equipped with a stir bar, a PTFE tube gas inlet sealed with a quick connect adaptor, a reflux condenser assembly sealed with a gas outlet valve, and a rubber septum. Once fully sealed, the flask was removed from the glovebox and securely clamped on the heating block on the stir plate. Under N₂ purge, the mixture was heated to 130° C. The mix was maintained at 130° C. for ˜5 minutes, until completely homogenous, then the gas purge was switched to SO₂. SO₂ was bubbled through the reaction for 30 minutes at 130° C. Heating of the flask was stopped, and the reaction was allowed to cool under a slow SO₂ flow until most of the solid precipitated from the reaction. The gas flow was switched to N₂, and the system was purged for 5 minutes. A suspension of N-chlorosuccinimide in toluene (˜3 mL) was added to the reaction flask via syringe. The flask was reheated to 130° C. Once all solid had dissolved, the solution was stirred for 30 minutes at 130° C. After 30 minutes, heating was stopped, and the reaction was allowed to cool under N₂. Once cooled to ˜60° C. the reaction slurry was poured into a stirred beaker of MeOH (˜200 mL) to precipitate the polymer product. The MeOH suspension was stirred for 30 minutes, then the white solid collected by vacuum filtration, washed with additional MeOH, and dried overnight in a 50° C. vacuum oven. 0.98 g of solid was recovered. ¹H NMR analysis revealed approximately 15% of polyolefin chains had been functionalized to PE-SO₂Cl, with the remaining material being unfunctionalized polyolefin. Although this yield was comparatively lower relative to Example 2. it is believed that the lower yield was the result of residual 1-octene in the polymeryl aluminum reagent.

¹H NMR (500 MHz, tetrachloroethane-d2. 110° C.): δ 3.78-3.66 (m. 2.36 H, PE-SO₂Cl), 1.6-1.1 (br s, 4090 H, PE-SO₂Cl+PE-H), 0.98 (t. J=6.8 Hz, 73.35 H, PE-SO₂Cl+PE-H).

1. A method for preparing end-functionalized polyolefin, the method comprising:
polymerizing one or more olefin monomers in the presence of an aluminum chain transfer agent to produce a polymeryl aluminum species;
treating the polymeryl aluminum species with sulfur oxide compound at a reactor temperature to form a polymeryl sulfinate; and
oxidizing the polymeryl sulfinate;
wherein:
the end-functionalized polyolefin comprises a polymer backbone having at least 30 carbon atoms;
the end-functionalized polyolefin comprises a sulfur containing group, wherein the sulfur containing group is a sulfonyl halide.

2. (canceled)

3. The method of claim 1, further comprising hydrolyzing the sulfonyl halide to form a sulfonate salt.

4. The method of claim 3, wherein the sulfonyl halide is selected from a sulfonyl chloride, sulfonyl bromide, or sulfonyl fluoride.

5. The method of claim 1, wherein the sulfur oxide compound is sulfur dioxide.

6. The method of claim 1, wherein the reactor temperature is greater than 100° C.

7. The method of claim 6, wherein the reactor temperature is from 110° C. to 150° C.

8. The method of claim 1, wherein the process further comprising polymerizing one or more olefin monomers in a solution reactor.

9. The method of claim 1, wherein oxidizing the polymeryl sulfinate to the end-functionalized polyolefin comprises an oxidizing reagent.

10. The method of claim 9, wherein the oxidizing reagent comprises chlorine (Cl₂), bromine (Br₂), fluorine (F₂), N-chlorosuccinimide, 1,3-dichloro-5,5-dimethylhydantoin, trichloroisocyanuric acid, N-bromosuccinimide, 1,3-dibromo-5,5-dimethylhydantoin, dibromoisocyanuric acid, 1-chloromethyl-4-fluoro-1,4-diazoniabicyclo[2.2.2]octane bis(tetrafluoroborate) (also known as Selectfluor™), 1-fluoropyridinium tetrafluoroborate, or N-fluorobenzenesulfonimide.

11. A sulfonate end-functionalized polyolefin according to formula (I): 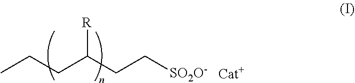
where n is an integer from 15 to 5,000, each R is independently hydrogen atom or (C₁-C₁₀)alkyl and Cat⁺ is a countercation.

12. The surfactant of claim 11, wherein Cat⁺ is a proton (H⁺), a cationic alkali metal or a cationic alkaline earth metal.

13. The surfactant of claim 11, wherein Cat⁺ is selected from the group consisting of aluminum, sodium, lithium, potassium, calcium, or magnesium.
